(19) United States
(12) Patent Application Publication
(10) Pub. No.: US 2011/0167008 A1
(43) Pub. Date: Jul. 7, 2011

(54) DATABASE LICENSING AND CUSTOMER SERVICE SYSTEM FOR WIRELESS CAMERA FLASH SYSTEMS

(75) Inventor: Kevin James King, Vancouver, WA (US)

(73) Assignee: Leap Devices, LLC, Vancouver, WA (US)

(21) Appl. No.: 12/986,788

(22) Filed: Jan. 7, 2011

Related U.S. Application Data
(60) Provisional application No. 61/293,145, filed on Jan. 7, 2010.

(51) Int. Cl. G06F 17/30; G06Q 10/00

(52) U.S. Cl. 705/304; 707/769; 707/689; 707/E17.014; 707/E17.005

(57) ABSTRACT

A device, system, and method is disclosed. The device may be a photographic asset that may include one or more functional features configured to enable the photographic asset to perform one or more functions. The device may have a memory configured to hold a photographic asset identifier. The device may include a communication mechanism which may be configured to couple with a data handler and to provide the asset identifier to the data handler, and to receive a licensure status from the data handler, the licensure status obtained from a cross referencing of the asset identifier against a license flag in a database. The database may include a copy of the asset identifier and the license flag, the license flag may include the licensure status. The device may also include an enabling or disabling feature to respectively enable, or keep enabled, at least one of the one or more functions when the licensure status indicates that the at least one function is licensed, and to not enable or to disable the at least one function when the licensure status indicates that the at least one function is not licensed.

### CROSS-REFERENCE TO RELATED APPLICATIONS

The present application claims priority to U.S. Provisional Patent Application No. 61/293,145, filed Jan. 7, 2010, entitled “Database Licensing and Customer Service System for Radio Wireless Camera Flash Systems,” the entire disclosure of which is hereby incorporated by reference in its entirety.

### FIELD

The present invention relates to one or more photographic devices each having one or more functions useful for taking photographs, and more specifically to a photographic device, system, and method wherein the one or more functions may be enabled or disabled based on a licensure status of the one or more functions, and wherein the one or more photographic devices may be identified by a unique identifier which may be used to determine the licensure status, and/or used by a customer service person to identify the asset, determine settings of the asset, and/or settings of other photographic assets coupled with the asset.

### BACKGROUND AND SUMMARY

There are currently a wide variety of hardware systems and software systems available to perform various tasks useful to photographers, and/or persons, or operations which support photographers (“user(s)”). Such systems may include, but may not be limited to: cameras; camera lighting equipment; various communication equipment which may provide various wireless functionality or interconnectivity between cameras, lighting equipment, and other photographic control equipment, as well as various software components which may operate on circuitry of a camera; circuitry of various communication equipment; circuitry of various photographic lighting equipment; as well as software or software packages or software components which may operate on personal computing devices such as, but not limited to, personal computers, laptop computers, cellular phones, personal digital assistants (“PDA(s)”), and the like. Together, in whole, in part, in any order or combination, these devices and systems may be referred throughout the present disclosure as “photographic assets”.

As more photographic assets become developed and commercially available, several challenges may emerge for the manufacturers of the photographic assets, as well as for the end users or consumers of photographic assets.

Often times, a manufacturer of photographic assets may produce different hardware devices. Each device may be intended to fill the needs of different market segments. A lower cost photographic device may have a lesser number of features, or less complex features, which may be relatively less useful to an end user. A more costly device may have a greater number of features, or more complex features, and may be relatively more useful to the end user. The choices available to the consumer of photographic assets may also include one or more devices that may be configured to enable wireless communication between, a camera and various pieces of photographic equipment, such as, for example, various lighting devices. In some cases, the communication may enable remote wireless control of the camera and/or of the photographic equipment. These wireless enabled devices may also include varying degrees of complexity and varying numbers of features, and may therefore be sold at various price points. Manufacturers may also recognize the need for producing various photographic assets which may scale well in terms of design and functionality, and which may match changing budgets and needs of one or more groups of end users.

As stated, a manufacturer of photographic assets may need to design, tool, manufacture, and supply a large number of models, or versions, of physical devices to supply various market segments. Moreover, an end user, who may be a novice user and therefore be considered to be in a first market segment, may have to choose between a lower cost device having the features they require immediately, and are currently familiar with, and a more expensive device, with a greater feature set that they will later be able to use effectively as they progress in knowledge, and technical skill. The user may be faced with the choice to either purchase a more expensive device having features they may not understand which may further hinder their ability to grasp and understand basic techniques, or to purchase a lower cost device while knowing it will need to be replaced in the future. Purchasing two different devices over time may be more costly to the end user.

Manufacturers may also face challenges that may include attempting to provide customer service, and/or technical support, to various end users. Some end users may lack advanced technical skills in the field of photography, and they may require various degrees of support in order to understand, set up, maintain, and otherwise operate various photographic assets. Often, an end user may contact a customer support service provided by a manufacturer of photographic assets by telephone, wherein a customer support technician must attempt to diagnose or solve an issue presented by the user. The interaction between user and technician may only include a voice conversation, and have little or no visual reference. The end user may be confused or challenged in understanding the instructions provided by the customer support technician. Consequently, providing effective customer support may be difficult.

A manufacturer may enable greater functionality of a more expensive device so as to make the device more valuable to an end user and thus increase sales of the more expensive device having the greater functionality, while the actual difference in manufacturing cost of the hardware between a device having greater functionality and a device having lesser functionality may be negligible to the manufacturer. The manufacturer may choose to absorb the cost of development and manufacturing of multiple models or versions of devices so as to provide devices which may fit the market and needs of various end users whose need for expanded functionality may vary considerably from one user to another. In this way, the manufacturer may provide multiple devices targeted to different portions of a user market. For example, one device may have a lower retail price targeted at the functionality requirements of a novice user, and another device may have a higher retail price targeted at the functionality requirements of more advanced users. The described methodology of providing multiple models or versions of devices may be of a cost disadvantage to a manufacturer and may also be of a cost disadvantage to end users.

One solution to the described disadvantages may be in providing multiple versions of a firmware which may operate circuitry of a device and thus provide that device various functionality, wherein one firmware may be of lower cost and provide lesser functionality while a another more costly firmware may provide greater functionality. This approach may cause some inconvenience to a user as replacing an entire firmware or portion thereof may require time, and complete revisions of firmware may still not provide a user with the specific features and/or functionality desired by a particular user.

Embodiments in accordance with the current disclosure may address and solve the above discussed challenges in various new and novel ways which may be both cost effective and convenient to both manufacturers of photographic assets as well as end users of photographic assets.

Embodiments disclosed herein may provide various methods and systems to manage the licensing of various features and to provide customer service for end users for various systems and features of systems that may be used in the field of photography and the field of photography device communication. In various representative aspects, embodiments in accordance with the present disclosure may include a database or similar system that may record, store, manage, query, update, and/or otherwise correlate various portions of information that may correspond to various features, functions, software, the licensing of the former, customer information which may correspond to contact, billing, payments, past trouble tickets or cases, and the like. The various information may correspond to various hardware and/or software systems which may be in use in the field of photography, and the information may be stored in the database which may be available in a controlled way to various customer service and/or billing and/or similar support operations. The database may be remotely accessible via a computer network, local area network, wide area network, wireless mesh network, the Internet, a telecommunications network such as a cellular network, satellite network, and the like. The database may be queried, referenced, or otherwise of use to various hardware and/or software systems which may be used in the field of photography. A data handler which may, for example, include circuitry or software of various hardware and/or software systems used in the field of photography which may be configured to query, or enable a query of the database for various data which may correspond to licensing information or other information of use to the circuitry or software, or system. The circuitry may query a database directly or via another circuitry, hardware, or software which may provide transport, connectivity, network, or bridging services to a database such as, but not limited to, a personal computer.

A “photographic asset” and/or “hardware device” may include any hardware, circuitry, apparatus, equipment, computing device, personal computer, or the like, or any portion or grouping or combination thereof (“photographic hardware”) and/or any software, firmware, software component, source code, machine code, operational process, subroutine, function, or the like, or any portion or grouping or combination thereof (“photographic software”) wherein various photographic software may operate on, or in coordination with, various photographic hardware which may enable various electronic components comprised within the various photographic hardware to carry out any logical process, wherein a photographic asset may be of use to a user in the field of photography. Examples may include but, may not limited to, any device which may capture still images, moving images, video images, movies, on film and/or via digital means and the like. An example photographic asset may together, in whole, in part, or any example thereof be referred to as a “camera”. Other example photographic assets may be any device which may produce illuminating light for use in the field of photography such as, but not limited to, hand held or battery operated strobe flash units, studio flash units and/or power packs, constant on ‘hot lights’ lighting, light provided by LED (light emitting diode) devices, and the like. These example photographic assets together, in whole, in part, or any example thereof may be referred to as “lighting device”. Other example photographic assets may be any device which may enable any connectivity between any photographic hardware and/or any photographic software. Connectivity may include any combination of wired coupling via one or more physical electrical connection(s), a physical adaptor, a circuitry, an apparatus, etc. Communication of various signals may occur via any combination of wireless, or wired coupling using any of a variety of wireless technologies including but not limited to the transmission and/or reception of radio signals and/or optical signals and/or sound signals, or any order, arrangement, or grouping thereof such that one photographic asset may be able to communicate with at least one additional photographic asset. The described device enabling connectivity or any portion or communication method thereof together, in whole, in part, or any example thereof, may be referred to as a “communication device”. In some cases, photographic asset and/or hardware device may include any arrangement of camera, and/or lighting device, and/or communication device, singularly, in plurality, connected as individual devices or together in any combination.

Embodiments may provide a method which may include configuring a photographic asset, capable of performing at least one function useable in a photographic setup arranged to capture a photographic image, to include an enabling or disabling feature to respectively enable, or keep enabled, the at least one function when a licensure status indicates that the least one function is licensed, and to not enable or to disable the at least one function when the licensure status indicates that the least one function is not licensed. The method may also include associating a photographic asset identifier with the photographic asset. The method may also include configuring a database to include one or more records, each of the one or more records including a copy of the photographic asset identifier, and a related license flag, the license flag indicating the licensure status of the at least one function. The method may also include enabling a communication mechanism to communicate the photographic asset identifier to a data handler, the data handler configured to cross check the photographic asset identifier against the license flag in the database, and to return the licensure status of the at least one function to the photographic asset via the communication mechanism.

In some embodiments, the method may also include saving the photographic asset identifier in a memory included in the photographic asset. And in some cases the method may also include: providing a request interface whereby a user can request one or more licensable functions to be usable by the photographic asset; receiving a request via the request interface to make a licensable function usable by the photographic asset; setting a license flag in the database in response to the request in order to change the licensure status of the requested function from unlicensed to licensed; and communicating via the communication mechanism to the photographic asset that the requested function is licensed. The request interface is one of more of a telephonic interface, and an Internet based interface.

In some embodiments, the method may also include using a customer service interface at a location remote from the photographic asset to change one or more settings of the photographic asset and/or one or more settings of one or more photographic elements operatively coupled with the photographic asset.

The request interface may include one or more mechanisms whereby a user may communicate with a customer service person. The request interface may include a telephonic system that may utilize voice and/or data communication, or a computer network based system, and the like, or a combination of one or more systems. In some cases the request interface and the customer service interface may be the same interface. In other cases they may be different. The customer service interface may be configured the same as, or different from, the way the request interface is configured i.e. it may include any combination of voice, or data components and may utilize telephonic and/or computer network components, and may use the Internet.

In some embodiments, the method may also include: saving two or more settings from any combination of settings of the photographic asset or settings of one or more the photographic elements operatively coupled with the photographic asset as a collection of settings; associating a collection name with the collection; retrieving the two or more settings as the collection of settings by using the collection name as a search term; and communicating the collection of settings to the photographic asset, and thereby changing or affirming corresponding settings of the photographic asset and/or the photographic elements coupled with the photographic asset.

The collection of settings may be saved in the database. In this way a photographic environment which may include a photographic asset and other photographic assets, which may also be referred to as photographic elements coupled with the photographic asset, may be changed in a more efficient and cooperative way.

Some embodiments may provide a system. The system may include a photographic asset that may be configured to perform at least one function in a photographic setup. The photographic setup may be configured to capture a photographic image, the photographic asset may have a photographic asset identifier designated to identify the photographic asset. The system may also include a memory configured to contain at least a portion of a database. The database may include one or more records, each of the one or more records may include a copy of the photographic asset identifier, and a related license flag, the license flag indicating a licensure status of the at least one function. The system may also include a processor enabled data handler. In some cases the data handler may be a person, or it may be an automated, or semi-automated, element and may be, or may include software, or firmware. The system may also include a communication mechanism that may be configured to communicate the photographic asset identifier to the data handler, the data handler configured to cross check the photographic asset identifier against the license flag in the database, and to return the licensure status of the at least one function to the photographic asset via the communication mechanism. In addition, the system may include an enabling or disabling feature to respectively enable, or keep enabled, the at least one function when the licensure status indicates that the at least one function is licensed, and to not enable or to disable the at least one function when the licensure status indicates that the least one function is not licensed.

### BRIEF DESCRIPTIONS OF THE FIGURES

Embodiments of the present invention will be readily understood by the written description along with reference to the accompanying drawings and photographs. Embodiments of the invention are illustrated by way of example and not by way of limitation in the accompanying pictures and/or figures.

### BRIEF DESCRIPTION OF THE DRAWINGS

A more complete understanding of the present invention may be derived by referring to the description herein when considered in connection with the following illustrative figures. In the following figures, like reference numbers refer to similar elements and steps throughout the figures.

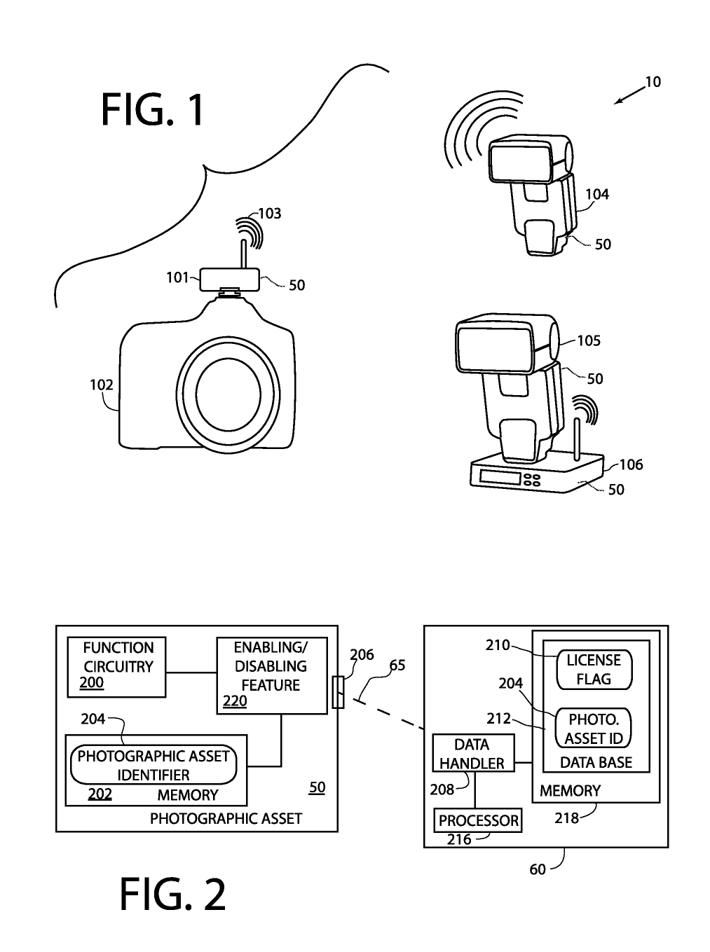

FIG. 1 is a system diagram illustrating an example system including several example photographic assets.

FIG. 2 is a schematic representation of an example photographic asset coupled with an example computing device.

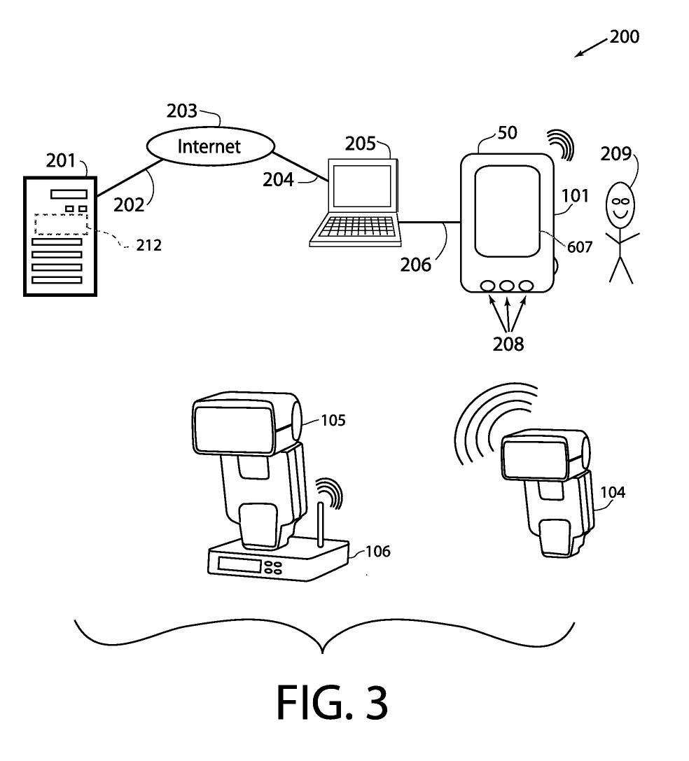

FIG. 3 is a schematic view illustrating an example system including a photographic asset which may have a means of communicating with a remote server via various portions of one or more networks.

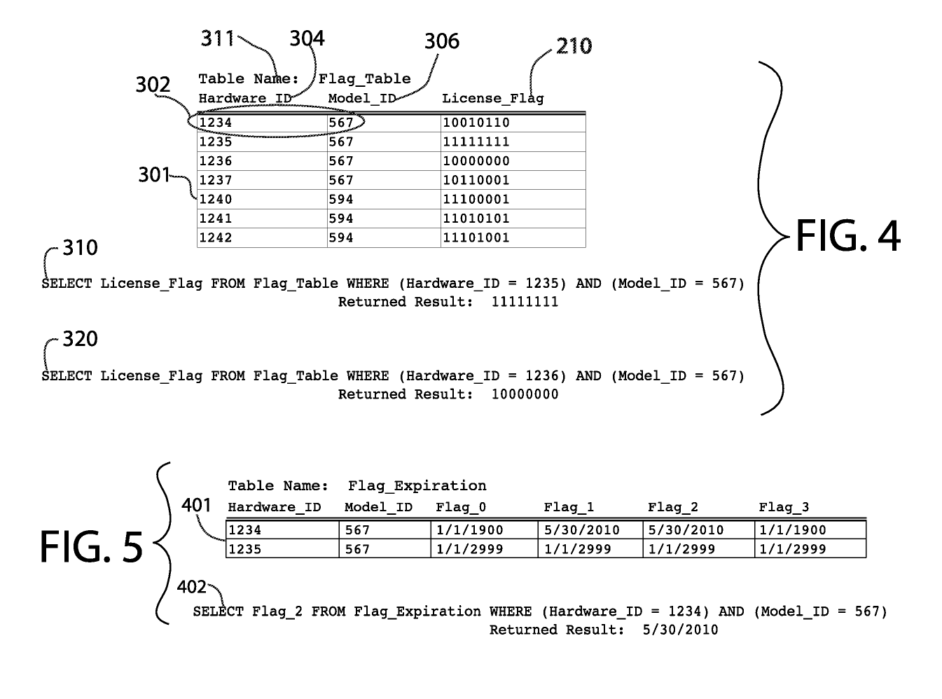

FIG. 4 illustrates a table of a database which may be used to relate a photographic asset identifier to one or more license flag(s), and example queries that may be used to retrieve various data from the table.

FIG. 5 illustrates a table of a database which may be related to the table illustrated in FIG. 4, and which may, or may not, be included in the database discussed in reference to FIG. 4, which may be used to relate a photographic asset identifier to one or more license flag(s), and example queries that may be used to retrieve various data from the table.

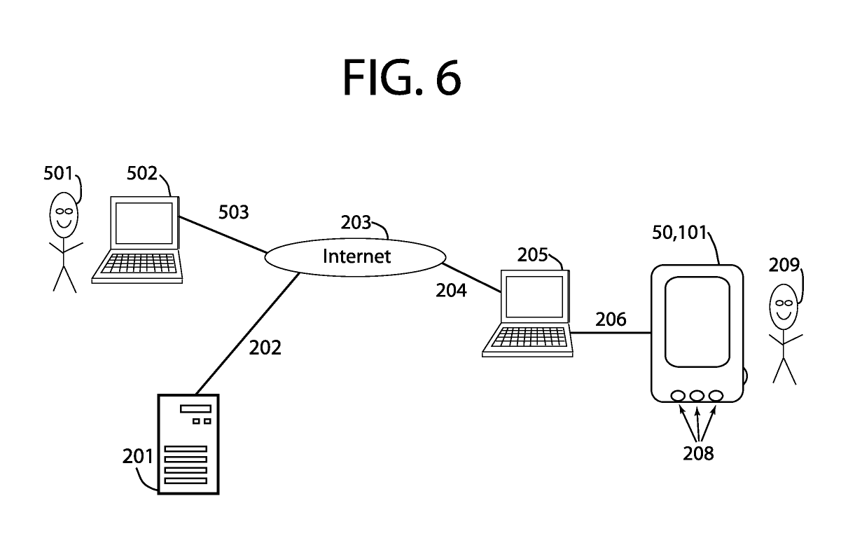

FIG. 6 is a system diagram illustrating a simplified example coupling of a customer service operation, a network, and at least one photographic asset.

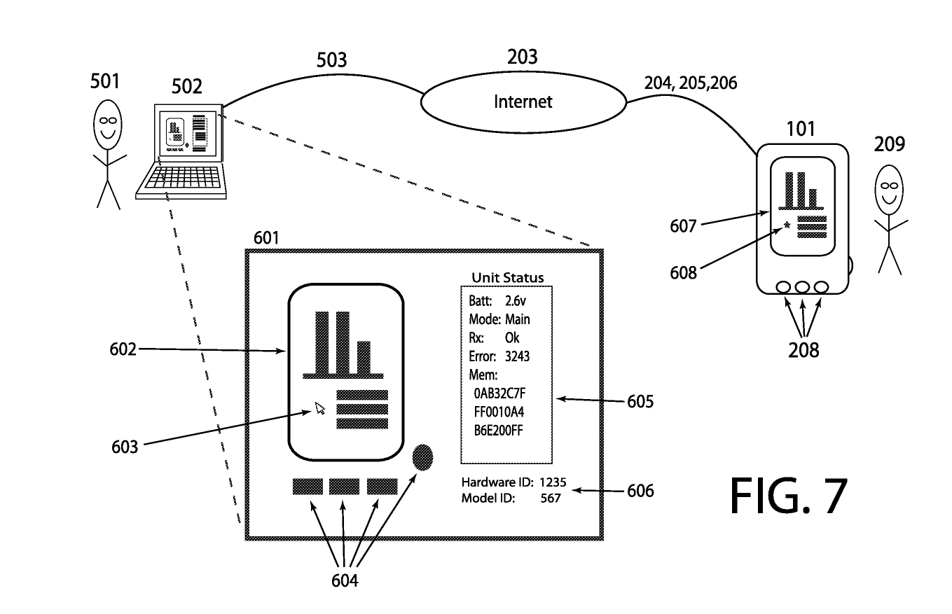

FIG. 7 is a system diagram illustrating a simplified example coupling of a customer service operation, a network, and at least one photographic asset, and a computer screen of a customer service operation having remote control via a network of at least one photographic asset.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB),” that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

FIG. 1 is a system diagram illustrating an example system 10 including several example photographic assets 50. Various systems may include various numbers of photographic assets which may also be referred to as photographic elements herein. One photographic asset 50 may be a communication device 101 which may be coupled to a second photographic asset such as a camera 102. The communication device 101 may communicate various ways, for example, wirelessly with other devices or photographic assets using radio signals 103 or other wireless communication method such as, but not limited to, a pulsed light signal, etc. Still more photographic assets 50 may be used together, for example, a lighting device 104, which may be remote relative to the communication device 101, may have an ability to be interacted with via a wireless communication via radio signals, pulsed light signals, and the like, via a wireless functionality comprised within the lighting device 104. Another photographic asset such as a second lighting device 105, which may also be remote, may be coupled to a photographic asset such as a second communication device 106 which may provide wireless functionality to the lighting device 105.

A “database” as used herein, may refer to any organized collection of any data, information, markers, flags, binary bits, binary bytes, strings of alpha and/or numeric characters, integers, numbers, comparisons and the like (hereafter “data element(s)”); and wherein a database may be able to relate any given data element or collection of data elements to any other data element or data elements. The database may be, or may include, any conceivable arrangement of data organized as individual files, portions of files, or records which may be arranged in any logical or meaningful sequence. The files may include, but may not limited to, various delimited files such as, but not limited to, tab delimited, comma delimited, etc. The database may reside on one or more computing devices such as one or more computers or computer servers which may allow a user, or software or process, to query a data element or collection of data elements, insert a data element or data elements, update or change a data element or data elements, copy one or more data elements, delete data or data elements, and the like. The data, together, in whole, individually, or in any sequence or combination may be queried using one or more data handlers or querying tools. A database may be able to store repetitive collections of data which may be similarly formatted as one or more records (“data record(s)”), and wherein each data record may comprise one or more data elements which may be of similar or dissimilar types of information, and wherein the data elements may be organized as fields or columns of a data record (“data field”).

The database may be managed and/or acted upon by a database management system, or data handler, or querying tool. The database management system may include software such as, but not limited to, MySQL available under open source public license, Oracle, SQL Server available commercially from Microsoft Corp., Excel, Access, FileMaker, relational database systems.

A “license flag” may refer to any data, information, markers, flags, digital bits, digital bytes, string of alpha and/or numeric characters, integers, numbers, comparisons and the like which may reference a feature, or collection of features, or a function or collection of functions, or software or collection of software, or process or collection of processes which may be carried out, executed, activated, used, etc, by a photographic device, photographic element or photographic asset, or by a group of photographic devices, elements, or assets or by a photographic software, or a collection of photographic software, or any combination thereof. A license flag may be stored as a data element within a database. A “licensed function” may refer to any feature, or collection of features, or a function or collection of functions, or software or collection of software, or process or collection of processes which may be carried out, executed, activated, used, etc, by a photographic device, or by a group of photographic devices, or by photographic software, or a collection of photographic software, or any combination thereof. A license flag may correspond to a licensed function. A licensed function may be enabled or allowed based on the status of a license flag; and/or a licensed function may be disabled or not allowed based on the status of a license flag; and/or a licensed function may be limited to some capacity or allowed to some capacity based on the status of a license flag. For example, a given photographic hardware may comprise a photographic software which may be able to carry out a process that causes an electrical contact of a photographic hardware to be forced from a high voltage to a low voltage whereby the forcing low of a voltage may cause a photographic lighting device to emit light, wherein the described process may be a licensed function; and wherein a license flag may correspond to the described licensed function which may correspond to the described process; and whereby the database may store the license flag as a data element of a database; and whereby if the stated license flag may be set within the database, the described licensed function may be carried out; and whereby if the stated license flag is not set within a database, the described licensed function may not be carried out. The setting of the licensed flag may be may be referred to as setting a licensure status of a licensable feature as licensed. The “un-setting” or lack of setting of the licensed flag may be may be referred to as setting the licensure status of the licensable feature as unlicensed.

A “remote server” may refer to any computing device or collection of computing devices which may store the database and/or provide various access and/or functionality or services to the database. The remote server may have a connection to a computer network which may include a local area network, a wide area network, the Internet, an intranet, a mesh network which may be wireless, a wired network, a wireless network, a telecommunications network, a cellular network, a satellite network, a network formed by a proprietary method, a network formed by a hardware and/or technology yet to be developed, or any other arrangement which may allow one or more computing devices to communicate information and/or signals between each other directly or via various intermediate computing devices such as but not limited to routers, firewalls, bridges, and the like. These example computing device or collection of computing devices may together, in whole, in part, or any example thereof be referred to as a “network”.

In accordance with various example embodiments in accordance with the present disclosure, the database may reside on the remote server which may be accessible via a network. The remote server may have an identifier or address assigned such as but not limited to a TCP/IP address (hereafter “address”). The remote server may be accessible via an address to another computing device via the Internet.

In accordance with an example embodiment of the present invention, a photographic asset may have a photographic asset identifier, or simply “asset identifier”. The asset identifier assigned may also be referred to as, or include a “hardware ID” which may be any number, data, pattern, string, binary bit sequence, serial number, or otherwise which may correspond to one or more data elements of a database of a remote server. A hardware ID may be unique such that it is impossible or unlikely that any two photographic asset devices will ever have the same hardware ID, wherein a hardware ID may be unique to a specific individual unit of a photographic asset worldwide, or a specific geography. It is considered by the present disclosure that a hardware ID may be assigned by a manufacturer of the photographic asset and stored within a memory which may be configured within a hardware or software of the photographic asset; or a hardware ID may be entered by a user; or a hardware ID may be assigned during a process of distributing a photographic asset, or during the process of selling a photographic asset to an end user, or any time during or between the initial manufacturing process of a photographic asset and a user's normal use of a photographic asset. It is considered by the present disclosure that a hardware ID may not necessarily be unique globally or nationally, but rather a hardware ID may be unique among various photographic assets within a given geographic area, a hardware ID may be unique among hardware ID's assigned by a specific manufacturer, or a hardware ID may be unique among individual units of various photographic assets of a specific model or group of models of a photographic asset(s), or a hardware ID may be unique among various photographic assets used or purchased by a given company, employer, or manager of an end user or users, or a hardware ID may be unique among various photographic assets used or purchased by a group of end users, or a hardware ID may be unique among various individual photographic assets currently being used at a given time by an end user or any group of end users.

FIG. 2 is a schematic representation of an example photographic asset 50. As illustrated the photographic asset 50 may be coupled with a computing device 60 as illustrated schematically with coupling 65. The computing device 60 may be remote from the photographic asset 50, and the coupling may be enabled in various ways such as with a wired coupling, or a wireless coupling, as described herein, and may include one or more intermediate devices that may be configured as a communication, or computer network, also as described herein. The photographic asset 50 may include one or more functional features as illustrated with functional block 200 which may include, for example, functional circuitry 200. The functional circuitry 200 may be configured to enable the photographic asset 50 to perform one or more functions. The one or more functions may be one or more functions that may be described herein, such as emitting a flash, or communicating with another photographic element, or the like. The photographic asset 50 may also include a memory 202 that may be configured to hold a photographic asset identifier 204.

The photographic asset 50 may also include a communication mechanism 206. The communication mechanism 206 may include, or may be coupled with the coupling 65, and may be configured to couple the photographic asset 50 with a data handler 208 and to provide the asset identifier 204 to the data handler 208. The communication mechanism 206 may be considered to include the coupling 65, or it may be considered otherwise.

The communication mechanism 206 may also be configured to receive a licensure status from the data handler 208. The licensure status may be obtained from a cross referencing of the asset identifier against a license flag 210 in a database 212. The database 212 may include the asset identifier 204 and the license flag 210. The license flag 210 may include, or may determine, or be used to determine, the licensure status.

The photographic asset 50 may also include an enabling or disabling feature 220 to respectively enable, or keep enabled, at least one the one or more functions 200 when the licensure status indicates that the least at one function is licensed, and to not enable or to disable the at least one function 200 when the licensure status indicates that the at least one function 200 is not licensed.

The data handler 208 may be enabled by a processor 216. The data base 212 may be saved within a memory 218. The data handler 208 and the memory 218 may be included within the computing device 60.

The communication mechanism 206 may be included in the photographic asset 50, coupled with or included partially, or completely, in the photographic asset 50. The communication mechanism 206 may also, or instead, be embodied in separate components that may be configured to act cooperatively, and may include, for example, various elements of a network. The network may be, or may include, computing devices coupled with the Internet, and/or telecommunication devices on a telecommunication network.

In accordance with an example embodiment in accordance with the present disclosure, a photographic asset may have a second identifier assigned (hereafter “model ID”) which may be any number, data, pattern, string, binary bit sequence, serial number, or otherwise which may correspond to one or more data elements of a database of a remote server. A model ID may be unique to a group of photographic assets, for example but not limited to, a single model ID being assigned to each unit produced having the same model number, version number, manufacturer, use, classification, firmware version, software version, firmware configuration, feature set, or any other parameter that may be used to logically group a collection of individual photographic asset devices wherein the group may comprise all units produced of a photographic asset having the same model number, version number, etc. In one example (provided for illustration and not limitation—it is clear that any number of variations may be possible beyond those noted for clarity and simplicity herein), a manufacturer may produce three different models hardware devices, wherein each hardware device may be available in two different versions. A unique model ID may be assigned for each model and version of hardware device and thus the manufacturer may use six different model ID's. It is considered that a given model and/or version number of a photographic asset may use more than one model ID.

In accordance with an example embodiment of the present invention, a photographic asset may have a third identifier assigned (hereafter “manufacturer ID”) which may be any number, data, pattern, string, binary bit sequence, serial number, or otherwise which may correspond to one or more data elements of a database of a remote server. A manufacturer ID may be unique to a given manufacturer or photographic assets, such that all devices produced by a given manufacturer may have the same or substantially similar manufacturer ID. It is considered that a given manufacturer does not necessarily have to use a single manufacturer ID.

It is considered that an essentially endless combination of possible identification numbers may be used to represent an essentially endless number of groups, parameters, types, versions, manufacturers, etc, of photographic assets. It is considered that at least one useful benefit according to the present disclosure may be to enable a potentially massive number of varied makes, models, versions, individual production units of any, or all, examples of photographic assets to be logically referenced or related to by a database, such that any system, method, significance, placement, order, or grouping of identification numbers, etc, should be scalable so as to easily add new photographic assets from individual manufacturers or groups of manufacturers to some sort of system or logical ordering or scheme of referencing any various individual photographic asset or any conceivable grouping of photographic assets to a corresponding data element of a database; and wherein the number of manufacturers, makes, model numbers, versions, etc of the photographic assets may theoretically comprise any count of photographic assets ranging from a single photographic asset to all photographic assets in use, designed, and/or manufactured worldwide. Throughout this disclosure a “unit identification” or “photographic asset identifier”, or “asset identifier” may be used to refer to any combination or grouping or arrangement of a hardware ID, device ID, manufacturer ID, serial number, or other identification scheme which may allow a photographic asset to be identifiable to any other photographic hardware, photographic software, database, remote database, network, remote server, or any combination thereof.

Example Licensed Functions Embodiments

There may be an endless combination of specific examples or methods in accordance with the present disclosure. An example mode of manufacture and implementation is presented in this disclosure, although it will be clear to the reader that the present discussion seeks to illustrate the novel functionality which may be provided by the present invention and thus the discussion herein should not be construed as any limitation as to any exact configuration of logical process, software, arrangement of computing device(s), database(s), data element(s), remote server(s), network(s), photographic hardware, photographic software, photographic asset(s), user(s), and the like.

FIG. 3 is a schematic view illustrating an example system 200 including a photographic asset 50 which may have a means of communicating with a remote server 201 via various portions 202, 203, 204 of one or more networks. The means of communicating may be, or be facilitated by, the communication mechanism 206. The communication mechanism 206 may, in some cases, include one or more intermediate devices 205 which may have a means of signaling or communication (such as for example a USB connection with a photographic asset 50 which may be used by a user 209. As discussed the remote server 201 may include the database 212.

In one example embodiment, a piece of photographic hardware 101, i.e. a photographic asset 50, may comprise a circuitry, or other memory which may store a hardware ID and a model ID. The hardware ID may be unique within every individual unit produced which may have a given model ID. The model ID may be unique to the group comprising all individual production units of a photographic hardware produced by a given manufacturer which may have the same model number and hardware version. A remote database (which may reside on one or more remote servers 201) may comprise a data record comprising various data elements or data fields which may be related to a hardware ID of an example photographic hardware, and wherein a hardware ID of an example photographic hardware may be related to a model ID of the example photographic hardware. A remote database may comprise also one or more license flags which may relate to a given hardware ID; wherein a hardware ID may be unique, or may correspond to a model ID. A piece of photographic hardware 101 may comprise photographic software, wherein one or more processes which may be carried out by the photographic software of the photographic hardware 101 which may cause a desired or useful response or functionality of a circuitry of the photographic hardware 101 or a photographic asset 50, i.e. 101, 104, 106 perceptible of, or otherwise in communication with, a photographic hardware 101 may be individually, as groups, or in any combination referenced as one or more individual licensed functions. One or more license flags may be stored as a data element or group of data elements of a database, which may reside on a server which may be a remote server 201 which may have a connection 202 to a network such as but not limited to the Internet 203. The one or more license flags may correspond to the one or more individual licensed functions.

A given piece of photographic hardware may comprise a circuitry and/or photographic software which may allow the photographic hardware to communicate with a network, or communicate with a device which may provide connectivity to a network. For example, a photographic hardware 101 may comprise a USB (universal serial bus) port and a circuitry and/or software which may enable a circuitry of a photographic hardware to communicate signals and/or data to another device via USB 206 or other appropriate communication means; and wherein a USB port of a photographic hardware may be connected or otherwise allowed to communicate with a USB port of, for example, a personal computer 205 which may be an intermediate device; and wherein the personal computer 205 may have connectivity 204 to a network 205; and wherein the network 204 may have access or connectivity with a remote server 201 which may comprise a database or a remote database; and wherein photographic software running on the personal computer 205 may be able to query or otherwise interact with a remote database; and wherein the photographic software running on the personal computer may be able to reference a remote server 201, database, or remote database via an address of the remote server, database, or remote database; and wherein the personal computer 205, network, photographic software, USB connection 206, or any combination thereof may allow the photographic hardware 101 to query a remote database which may reside on at least one of a remote server 201 via the personal computer 205; or the photographic software running on the personal computer may be able to query a remote database based upon any signals or data communicated to or from a photographic hardware via the USB connection; and wherein the photographic software running on the personal computer may be able to communicate signals or data to or from the photographic hardware via the USB connection based upon a query made to a remote database or based upon one or more data elements returned from a remote database. It is considered that the USB connection 206 may be the best mode of manufacture to allow the photographic hardware 101 to have connectivity to a network via an intermediate device 205, though it is clear that other technology, connectivity, protocol, etc, used to allow an intermediate device such as personal computer 205, a wireless router, etc, to communicate with the photographic hardware 101 may be used.

Thus it is clear that any photographic hardware 101 may be designed such that the photographic hardware 101 may be able to directly access a network and thus access a remote database accessible via a network, or a photographic hardware may be able to communicate with a third component, device, or circuitry such as but not limited to a personal computer, PDA, etc (“intermediate device”) 205 in which the intermediate device may have access to a network 204, 203, 202 and thus have access to a remote server 201 which may comprise the database which may be a remote database; and thus various communication of signals and/or data may be possible between a photographic hardware, photographic software, photographic asset 101, or any combination or arrangement thereof, and an intermediate device 205, and the remote database in any combination, sequence, or arrangement. The photographic software may run on the intermediate device 205 and the photographic software may participate in, coordinate, control, or otherwise manage a communication or interaction between the photographic hardware 101 and the remote database which may reside on one or more remote servers 201.

A photographic asset 50 may be may be, for example, a communication device 101 (though it is understood in a similar example, the photographic hardware may be any photographic hardware such as but not limited to a camera 102, a lighting device 104, 105, etc. (FIG. 1)), wherein the communication device 101 may comprise an apparatus and circuitry, and wherein the communication device 101 may comprise a radio signal transmitter and/or radio signal receiver, and wherein the communication device may be able to become coupled to the camera 102 such that the communication device 101 may be able to send or receive various signals or indicators from the camera 101 to other photographic assets 104, 105, 106 which may themselves have an ability to transmit and/or receive radio signals; and wherein the communication device 101 may provide a user interface including but not limited to a graphic display 607 and various buttons or controls 208 whereby a user 209 may be able to make inputs or selections to the communication device 101. The described communication device 101 may comprise a circuitry and a firmware which may be capable of executing various functions, wherein one or more of the functions may be licensed functions. A manufacturer may produce at least a single model and/or hardware version of a device or photographic hardware which may be capable of executing one or more licensed functions.

The photographic asset may include a user display 607 configured to display one or more settings and/or status indicators of the photographic asset and/or one or more photographic elements operatively coupled with the photographic asset. The communication mechanism is further configured to communicate with a remote display and to cause the remote display to display a representation of the one or more settings and/or status indicators of the photographic asset and/or the photographic elements operatively coupled with the photographic asset.

The communication mechanism may be further configured to communicate with an interface accessible to a service person at a location remote from the photographic asset. The interface may be configured to allow the service person to observe one or more settings and/or status indicators of the photographic asset and/or photographic elements operatively coupled to the photographic asset.

Upon observing the settings and/or status of the photographic asset and/or the settings and/or status of any or all other photographic elements that may be coupled with the photographic asset the service person may advise the user on using different settings to improve the quality of the user's photographs. In some embodiments the interface may be configured to allow the service person to make suggested setting changes for the user. The changes may be communicated via the communication mechanism.

The described example photographic hardware or communication device may comprise hardware or software which may comprise a unit identification or any other means of identifying a given individual production unit of the example photographic hardware. A user may be able to cause the example photographic hardware to become coupled to a personal computer via a USB connection. Photographic software of the personal computer may query the unit identification of the example photographic hardware. Photographic software of the personal computer may then, via for example a connection to a network, send a query to a remote database which may request a response containing one or more data elements of the remote database which may comprise one or more license flags. The photographic software may then send signals to, or from, the photographic hardware via the USB connection which may enable or disable various licensed functions of the photographic hardware which may correspond to the one or more license flags returned from the remote database.

Thus, it may be possible to cause one or more licensed functions to become enabled or disabled, or otherwise governed based upon the status of one or more license flags which may be stored in a database. The status of one or more license flags may determine the licensure status of a particular function that the photographic may be capable of performing.

FIG. 4 illustrates a table 301 of a database which may be used to relate a unit identification 302, which may be usable as asset identifier 204 as discussed above, to one or more license flag(s) 210. The example illustrated shows the unit identification, or photographic asset identifier 302 as including the hardware ID 304 and model ID 306.

The database table 301 may comprise for example, at least one data record and at least one data field which may comprise at least one data element. For example, three fields may be present: Hardware_ID 304 which may store a hardware ID of a photographic asset, Model_ID 306 which may store a model ID of a photographic asset, and License_Flag 210 which may store at least one of a license flag. Model_ID 306 may have a number such as an integer which may relate to a given hardware model and hardware version of a photographic asset. Hardware_ID 304 may have a number such as an integer that is unique among all photographic assets having a given model ID. License_Flag 210 may have data wherein each binary bit of the data may relate to or be mapped to a given licensed function or group of licensed functions of a photographic asset. A license flag 210 may be stored as an integer for example from 0 to 255 which may represent an 8-bit sequence of binary bits wherein each bit may relate to or be mapped to a given licensed function. For example, the first bit (bit 0) may relate to License_Flag zero—if the first bit (bit 0) is set (it is a binary 1) then it may represent that the licensed function or group of licensed functions controlled by License_Flag zero should be enabled or allowed in the photographic asset matching the Hardware_ID and/or Model_ID of the record comprising the given License_Flag. In a similar way, license flags may be stored as a sequence of binary bits, a hexadecimal notation, or any other method of storing a flag which may indicate an allowing or a not allowing of a function which may be a licensed function to be carried out by a given photographic asset.

An example simplified SQL query is shown in listing 310, wherein for example, a query is made of the table 301 which may have, for example, the name 311 ‘Flag Table’ wherein a License_Flag is queried which matches the passed Hardware_ID and Model_ID. The result in this example may be an 8-bit number or other result which may be correlated to an 8 bit number. In this example, a retuned result is binary ‘11111111’ (but could also be integer ‘255’, or hexadecimal ‘FF’, etc) which may indicate that licensed functions 0, 1, 2, 3, 4, 5, 6, and 7 are all enabled or allowed for the photographic asset having a model ID of ‘567’ and a hardware ID of ‘1235’. In a similar example 303, a query may be made to retrieve the License_Flag for a photographic asset having a model ID of ‘567’ and a hardware ID of ‘1236’ which may return a result as binary ‘10000000’ which may indicate that licensed functions 0, 1, 2, 3, 4, 5 and 6 are not allowed to be carried out by the photographic asset, but that licensed function 7 is allowed to be carried out by the photographic asset.

It is considered that each license flag 210 could be stored in a different data field of a data record and that an endless arrangement of organizing the relation of allowing or disallowing licensed functions to a given photographic asset are possible.

It may be possible for a manufacturer to design a photographic hardware and/or photographic software which may be embodied as a single hardware device for example, such that a photographic software may provide basic functionality of the single hardware device, while the photographic software may also provide one or more advanced features which may be of use or interest to a more advanced or more specialized user, wherein the one or more advanced features may be individually licensed or licensed as a group, wherein the one or more advanced features may be one or more licensed functions. (It is considered also that even basic functionality or an element of basic functionality may also be a licensed function). The described single hardware device may be sold to an end user at a lower cost having basic functionality, and when the end user has requirement for the one or more advanced features, said one or more advanced features may be enabled by causing one or more appropriate license flags which may be stored in a remote database to be set.

There may be various means and/or methods by which a license flag or license flags may be set or cleared in a remote database. A company or organization managing said remote database may provide a user interface to a customer service person or to an end user via a web page which may be viewable on the Internet. A user may contact a customer service person and may pay a fee to enable the one or more advanced features, and a customer service person may interface with the remote database causing the appropriate license flag or license flags to be set. Alternately, or in addition, a user may interface with a web page viewable on the Internet and may provide a payment or other information via the web page or web pages wherein the coding and software providing the web page or web pages may also be able to set a license flag or license flags of a remote database in response to request by the end user and possibly payment from a user.

In one example embodiment of the present invention, it may be desirable to ensure a hardware device, photographic hardware, photographic software, photographic asset, or any combination thereof be required to periodically query a remote database to check the status of any or all license flags. For example, a photographic software of a photographic hardware may interface with a real time clock of a circuitry of a photographic hardware which may cause any licensed functions to become disabled if the photographic hardware is not able to query a remote database within a given time period. For example, a real time clock may be used as a basis to require a hardware device to query a remote database every two weeks to refresh or update the status of any or all licensed functions based upon the setting of one or more license flags of a remote database, and if a query is not made to said remote database within a two week period, a photographic software of a photographic hardware may cause any or all licensed functions to become disabled permanently or until a query may be made to a remote database. It should be understood that any period of time shorter or longer than the stated two weeks may be used. This method may provide a period of time by which the enablement of a given licensed function or set of licensed functions of a photographic hardware may expire.

It is considered that such a timeout may be implemented with a facility or function which may allow a user to temporarily override a timeout using various means. One means may include a method of calling a customer service operation by telephone and exchanging codes or keys which may be generated by a photographic hardware which may temporarily re-enable certain licensed functions, etc.

In accordance with the present disclosure, several useful and convenient processes to enable or disable various licensed functions of a photographic software and/or photographic hardware may emerge as discussed in the following brief examples. It is clear that the useful and convenient processes are not necessarily limited to those specifically discussed; the following discussion is provided simply to clarify and better illustrate some of the useful benefits of the present invention.

A company may establish a remote database having various data elements which may be organized into various data records and/or data fields, wherein one or more data elements may comprise a unit identification (which may further comprise a hardware ID, a model ID, a manufacture ID, individually, together, singularly, in plurality, or in any combination or grouping) which may correspond to a given individual photographic hardware, photographic software, hardware device, photographic asset, etc; and may also comprise one or more data elements which may comprise one or more license flags; and wherein the one or more license flags may correspond to a given unit identification or grouping of unit identifications. A user which may be an end user may purchase a hardware device which may have a unit identification. The user may contact the company establishing the remote database via various means including directly, by telephone, via a web site interface, etc and may request various licensed functions of the hardware to become enabled. The company establishing the remote database (or another company which may otherwise interface with or manage the remote database, etc) may cause appropriate license flags to be set in the remote database which may correspond to a unit identification matching the unit identification of the hardware device purchased by the end user. The end user may subsequently connect the hardware device to a computer which may be via a USB connection, and a photographic software running on the computer may then use a network connection to query the remote database for the status of the various license flags which may correspond to the various licensed functions the hardware device may possibly have enabled. The photographic software of the computer and the photographic software of the hardware device may communicate such that the photographic software of the hardware device may appropriately cause the various licensed functions of the photographic hardware and/or photographic software to become enabled or disabled as appropriate and such that may correspond to the status of one or more license flags stored in the remote database.

It is possible and considered also that a company may provide various time periods or intervals to enable or disable various licensed functions via the setting or clearing of appropriate license flags. For example, an end user may purchase a license to operate a licensed function which does not expire, such that a license flag may be set permanently (and furthermore, upon querying said permanently set license flag, a hardware device may subsequently ignore a requirement for continual updating of status of license flags) such that a licensed function may be purchased which may not expire. Alternately, a licensed function may be purchased on a periodic basis, such as for example, on a month by month basis, wherein if a subscription or regularly paid license is not renewed, a license flag for the given licensed function may become cleared in a remote database, and where upon when a corresponding hardware device queries said remote database, the expired licensed function may become disabled or otherwise not renewed in the photographic hardware or photographic software of the hardware device, etc. Alternately, a licensed function may be enabled for a short period of time for example, for one day, or a weekend, or a week, etc. In such case, it may be possible for a data queried from a remote database to cause a photographic software of a photographic device to enable a licensed function for a specific period of time wherein upon the expiration of the specific period of time, a given licensed function may become disabled.

Various means may be implemented to relate a date or time at which a licensed function may expire to a license flag or unit identification. One example implementation of this functionality may be to save one or more data records in a remote database which may relate a unit identification to a date and/or time for each licensed function or license flag, such that an expiration date and/or time may be queried. FIG. 5 illustrates another table 401 of a database which may comprise at least one data record wherein each data record may comprise a unit identification (which may be comprised of one or more data fields comprising a hardware ID, model ID, manufacture ID, etc) as well as a data field related to each unit identification for each license flag which may relate to each licensed function. For example, a Hardware_ID and a Model_ID may be stored with one or more dates which may be stored in individual data fields, each of which may correspond to a given license flag. Each date may indicate an expiration date for the allowing of a given licensed function. A date long past may indicate that a function is not allowed, while a date long in the future may indicate that a licensed function need not be renewed or re-queried in the future. A date occurring in the foreseeable future may indicate a date on which a given licensed function may expire and may no longer be allowed to be performed by the photographic asset which may correspond to the unit identification corresponding to the given date.

In one example embodiment, for example, a SQL query such as that of listing 402 (which may provide an example of a simplified SQL query) may operate as follows. If it is required to find the date on which licensed function two will expire on a photographic asset having a model ID of ‘567’ and a hardware ID of ‘1234’, a query as that listed in 402 may be issued which may return a date such as May 30, 2010. On the date indicated, the photographic asset having a model ID of ‘567’ and a hardware ID of ‘1234’ will no longer perform the operation or functionality or licensed function controlled by licensed function number two, which may also be indicated by license flag two. In a similar way it may be possible to create a database table having a date on which a given licensed function or group of licensed functions may become enabled if it is desired to allow a given licensed function or group of licensed functions to become available at a future date later than the current date. A similar table may be able to be created having dates on which licensed functions may become available or may become enabled. Once a photographic asset is able to synchronize license flags, expiration dates, starting dates, or any combination thereof, the photographic asset may automatically enable the licensed function or group of licensed functions on the correct date by referencing a real time clock, and to automatically disable the licensed function or group of licensed functions on the correct date by referencing a real time clock. It is considered also that a real time clock of a photographic asset or a circuitry of a photographic asset may be synchronized to a current date and/or time queried from a remote server when communicating other signals with a remote server which may ensure the real time clock of the photographic asset remains synchronized to the current correct date and time.

Referring also now to FIG. 4, wherein another example query 320 is illustrated, it is considered that a photographic asset such as a communication device 101 may cause the query 320 to be made of a table 301 of a remote database which may return data corresponding to, allowing, or disallowing, one or more licensed functions. For those licensed functions which are currently allowed (as indicated by the license flag(s) queried from the database) the photographic asset such as a communication device 101 may subsequently query an expiration date from the table 401 (FIG. 5) corresponding to each of the allowed or enabled licensed functions. Photographic software of a photographic asset such as a communication device 101 may store the expiration dates in a memory or a circuitry (for example a non-volatile memory such as an EEPROM) of the communication device for each allowed or enabled licensed function. A real time clock of the photographic asset such as a communication device may subsequently relate the current calendar date and/or time to that stored data and/or time relating to the expiration date of each licensed function.

As described by the various embodiments of the present invention, it may occur that a licensed function may become enabled on a given photographic asset, then subsequently, the company, for example the company producing the photographic asset, may have need or desire to subsequently disable the same licensed function which may have been previously enabled of the photographic asset. For example, a user may purchase a licensed function for a period of six months under an agreement that the payment or fee for enabling the licensed function be paid regularly by payment installments during the active period; and wherein the agreed upon payment is not received; and wherein the company may subsequently desire to disable the function as a result of the non-payment. It may therefore be desirable and useful to ensure that the photographic asset regularly query the remote database to ensure all licensed functions are still marked as enabled in the remote database. This may be achieved by programming into a firmware or photographic software of a photographic asset a requirement to synchronize license flags or other licensing data with a remote server at regular intervals to maintain the continued enablement of the licensed function(s). The regular intervals may be referenced to, or derived from, a date and time of a real time clock of a circuitry of the photographic asset or other circuitry which may provide a reliable and substantially tamper proof means of counting off an interval of time which may be several days, several weeks, months, etc. If a photographic asset is not synchronized with the remote database within the required period of time, a user may be presented with a warning or reminder by a display or other indication of the photographic asset, and if the photographic asset is still not synchronized with the remote database for a period of time, the firmware or photographic software of the photographic asset may automatically disable the use of one or more licensed functions until the photographic asset is again synchronized with the remote database.

Thus, it may be possible for a user to purchase a photographic asset which may have no licensed functions enabled or a limited set of licensed functions enabled, and to cause license flags corresponding to the unit identification of the purchased photographic asset to be set in a remote database. The licensed functions may have an expiration date. The expiration date may be queried and stored within the memory of a photographic asset. The licensed functions may be operable or be able to be carried out by the photographic asset until the expiration date of the corresponding licensed function has elapsed.

In accordance with the present disclosure, several business methods may emerge. In one example business method of the present invention, a photographic asset may be made available for purchase to a user. The user may choose to enable individual licensed functions of the photographic asset, or licensed functions may be available for purchase as a group or package of licensed functions. Purchasing a group or package of licensed functions may be offered at a lower price than the price of offering the same licensed functions individually. Licensed functions may be stored in and referenced to a database which may be a remote database as in the method(s) previously described.

In yet another example business method in accordance with the present disclosure, licensed functions may be enabled for a limited period of time based on a variety of criteria. For example, a user may require the use of a licensed function only for a short time, for example, for a single day. The user may pay a daily rate for the use of said function. It may be possible to enable a function for the current day, or to set the enabling of a licensed function for a future date. In a similar way, a company producing a photographic asset may enable licensed functions or a group of licensed functions for one or more photographic assets for a limited time (a “promotional period”) at no cost or a reduced cost as a promotional effort. Furthermore, a company may offer a licensed function or group of licensed functions to be purchased by a user or users at a discounted or promotional rate for a period of time following the promotional period.

In yet another example business method in accordance with the present disclosure, licensed functions may be enabled based on a subscription model. For example, a user may pay a monthly fee to keep a licensed function or group of licensed functions enabled for a period of time, for example, a month. As the user continues to pay the monthly license fee, the expiration date of the licensed function may be extended by a period of time each time a payment is received. If the subscription fee is not received, the licensed function or group of licensed functions may become expired or disabled.

In yet another example business method in accordance with the present disclosure, licensed functions may be enabled permanently (a “one time purchase”) as a user pays a higher fee for the use of said licensed functions. The higher fee may still be lower than that would be paid over time by a subscription.

It is considered that any or all business methods may be used simultaneously wherein certain photographic assets may follow for example a subscription model, while other photographic assets may follow a model of a one-time purchase.

It is considered by the present invention that a facility or process may be implemented which may allow a user to transfer one or more license flags from a photographic asset having one unit identification to another photographic asset having a different unit identification. For example, if a user transfers ownership of a photographic asset to another user, the user may transfer any enabled licensed functions from the first photographic asset to another photographic asset.

Example Embodiment of Customer Service

In yet another example embodiment of the present invention, several systems, methods and processes may be made possible by which a customer service operation may better interact with a user with regard to setup, status, error conditions, and configuration of a hardware device. It may be desirable for a customer service operation to become aware of specific settings of a photographic software, photographic asset, hardware device, etc, during an interaction with a user.

FIGS. 6 and 7 are system diagrams illustrating various example embodiments in accordance with the present disclosure. A photographic asset 50, 101 which may comprise a unit identification may be connected to a computer 205 via a USB, wireless, or other suitable connection 206 wherein the computer 205 may have a connection to a network 204, or alternately, a photographic asset may be connected directly to a network 203 via a wired or wireless connection; wherein the network may have connectivity 202 to a remote server 201 and/or a remote database. A customer service person 501 may have access to a computer 502, and may also have access either directly or via a network 503 to a remote server 201 and/or remote database. When a user 209 contacts the customer service person 501, the customer service person 501 may be able to query various settings and/or status of the photographic asset 101 through any of various possible means, several of which may be discussed as follows.

The user 209 may place a photographic asset 101 into a mode which would allow the customer service person 501 to interact with the photographic asset 50, 101 (“assist mode”) wherein the photographic asset 101 upon being placed in assist mode may cause a data element to be set in a remote database corresponding to a unit identification of the photographic asset 50, 101. A customer service person 501 may query the remote database which may reside on the remote server 201 for any records which have an assist mode flag set, and from the returned records, may select the unit identification corresponding to the unit identification of the photographic asset in use by the user using any of various methods including but not limited to matching a unit identification to the customer's name, by matching a serial number of a returned record to a serial number the end user may be able to view on the exterior or via a display or user interface of the photographic asset, etc.

Other methods of correlating a given photographic asset which may be in an assist mode to a unit identification a customer service person may desire to interact with may include a photographic asset producing a short pseudo random number which may be displayed on a user interface of the photographic asset, wherein the pseudo random number is also sent and stored in a remote database as a data element corresponding to a unit identification of the photographic asset. When a customer service person queries the remote database for records which contain a data element which may contain a pseudo random number which may indicate that a given photographic asset is in an assist mode may return a record set containing one or more pseudo random numbers which may correspond to one or more photographic assets which may be in an assist mode. The user may verbally or via another means communicate the pseudo random number displayed on the photographic asset to the customer service person which may be able to select the record having the same pseudo random number from a list and thus, the customer service person may now be able to identify which photographic asset is being used by the user, and also may ensure that the photographic asset in use by the end customer may be in an assist mode.

Using any of various possible means, a customer service person 501 may be able to query a photographic asset 101 via network connection for various settings and/or status, or in addition to or alternately, a photographic asset which may be placed in an assist mode may transmit any or all status and/or settings information to a remote database where the information may be stored such that the information may then be queried by a customer service person.

It is considered that using the above described methods or similar methods, a customer service person may be able to establish a connection via software used by the customer service person with a photographic asset in an assist mode used by a user via a network, or otherwise perform a handshake with the photographic asset and may subsequently be able to directly communicate with the photographic asset via a network wherein said communication may not involve the storing or query of data in a database.

A customer service person 501 may be presented with a graphical display 602 on a computer screen 601 of a computer 502 which may be representative of a graphical display 607 of the photographic asset 101 which may be in an assist mode in use by the end user 209, and may also be presented with a data or collection of data 605 corresponding to any or all status and/or settings of the photographic asset. The customer service person 501 may be able to point to a coordinate location 603 of a graphical representation 602 of the graphical display 607 of the photographic asset 101 which may be displayed on a computer screen 601 using a pointing device such as a mouse, and the coordinate location of the pointer 603 may be read by a software of the computer 502 being used by the customer service person 501 and may be sent via a network back to the photographic asset 101 in use by the user 209. The photographic asset 101 in use by the user 209 may translate the received coordinate location of the pointer 603 into a dot, pointer, indicator, or other graphical element 608 which may be displayed on a graphic display 607 of the photographic asset 101. Thus, a customer service person may have a substantially representative depiction of the image or elements displayed on a graphic screen of a photographic asset in use by an end user, and may be able to point, gesture, or otherwise indicate with an input device such as a mouse on a local computer screen various aspects or elements of the graphic display while the customer service person may be talking to the end user via for example a telephone audio connection, and whereby the pointing, gesturing, or indications of the pointer of the customer service person may also be substantially represented or reproduced by an indicator or other visible element in substantially real time on the graphic display of the photographic asset being used by the end user. Thus, a customer service person may point to various settings, buttons, selectors, indicators, etc, while talking to or explaining such elements to an end user via a telephone conversation while at substantially the same time the end user can see the pointing of the customer service person on their photographic asset. This may enhance the user's ability to understand what is being explained by the customer service person.

In a similar way, a customer service person may be able to select or click or operate various controls or elements 604 present on a computer screen 601 used by the customer service person 501 wherein the various controls or elements 604 present on a computer screen are substantially related to the activation or operation of any or all physical controls 208 present on a photographic asset 101 which may be in an assist mode. For example, a photographic asset 101 may comprise a rotary dial and a select button 208 which may be used by the end user to operate or interact with the photographic asset. A graphic element, control, widget, etc, 604 may be presented on a computer screen 601 used by a customer service person which when operated via for example a mouse or pointing device the computer used by the customer service person may send signals via the network 203 to the photographic asset which may interpret and act upon the signals as if the corresponding physical control on the photographic asset were activated or operated by the user. Using this method for example, a customer service person 501 may interact with a photographic asset 101 remotely as if the customer service person were able to essentially remotely operate the physical controls, dials, selectors, buttons, etc, 208 of the photographic asset 101. This may speed the time and effort required for the customer service person to check various settings, perform functions, etc, without having to verbally instruct the user as to which controls to operate or how to operate them, etc.

A photographic asset in use by an end user may send one or more data to a computer system used by a customer service person directly or via a remote database or a remote server which may be able to be read, referenced, or queried by a computer system in use by a customer service person; wherein the one or more data may correspond to any process, thread, data, bit or binary sequence, etc which may be perceptible to the photographic asset in use by the end user. For example, a communication device may be connected via USB or wireless connection to a computer which may be connected to a network, wherein the communication device may query all available status, data, error conditions, and settings of its own processes, or the processes of for example a camera and/or lighting device to which the communication device is coupled, in communication with, or perceptible of, and may send the queried information to the remote server, remote database, or computer used by the customer service person; and wherein the said communication device may also send the current value of any or all volatile and/or non-volatile memory locations, current processes of a microprocessor which may be comprised within the communication device or comprised within another hardware or photographic asset of which the communication device may be perceptible of, various stack pointers of a microprocessor, as well as any data corresponding to any signal, value, voltage, data stream, or other element a microprocessor may be perceptible of, to the remote server, remote database, or computer used by the customer service person such that the customer service person may have available for troubleshooting and/or diagnostic any or all data, settings, error conditions, and/or status of the communication device, photographic asset, photographic hardware, photographic software, or photographic asset as well as any other photographic asset the communication device may be able to communicate with or otherwise query via any available means; the various data discussed together, in part, or any combination thereof “elements of user device data”.

A computer system used by a customer service person may further have the ability to alter any elements of user device data and communicate those altered elements back to a photographic asset in use by an end user either directly or via a remote database or remote server such that a data, setting, or status may be changed within a photographic asset in use by an end user and/or any other photographic asset which may be in communication with or perceptible of the photographic asset in use by the end user.

Thus, it may be possible for a user to contact a customer support person, and may be able to place a photographic asset such as but not limited to a communication device into an assist mode wherein via a network connection a customer service person may be able to see any or all status, settings, values, parameters, error conditions, etc of the photographic asset, as well as those status, settings, values, parameters, etc of any other device such as but not limited to a camera and/or lighting device to which the photographic asset may be coupled or in communication with or perceptible of. The customer service person may be able to use the various settings to troubleshoot, diagnose, or explain a condition or process to the end user. Furthermore, rather than or in addition to verbally explaining a process to an end user whereby the user may change a setting or status, the customer service person may be able to change the setting or status, communicate the changed setting or status via network connection directly or via a remote database or remote server back to the photographic asset which may implement or save or otherwise execute or use the changed setting or status. Thus a skilled or experienced customer service person may be able to quickly configure a photographic asset and any other photographic asset which may be coupled to the photographic asset to the appropriate configuration and/or status appropriate for the operation desired by the user.

It is considered also that a customer service person may be able to configure a photographic asset to a particular mode and having various settings configured in specific ways. The customer service person may cause these settings to be recorded or stored or saved in a record or collection of data which may be stored in a database which may be remote, or may also be stored in a memory of the photographic asset, such that the user may select the collection of settings from a stored list, and whereupon the user selecting the stored collection of settings, the settings may be set within the photographic asset, or the photographic asset may cause various settings or modes to be set in another photographic asset which is perceptible of the first photographic asset. Thus, a user which may be a novice user may require an elaborate or complex collection of parameters to be configured for a particular photographing situation. The user may not fully remember how to set the various parameters which may have been previously explained to them by a customer service person. Using the described method, a user may quickly recall all the settings or configuration discussed during a previous interaction with a customer service person by simply selecting the collection of settings from a list which may have a meaningful name which may be set by the user or the customer service person.

For example, a photographic asset which may be a communication device may be configured to communicate with a camera to which the communication device is coupled, as well as communicate wirelessly via radio signals with a second camera as well as communicate wirelessly via radio signals with several lighting devices which may be configured to establish a particular ratio of light emitted from the several lighting devices. Setting up a communication with the various photographic assets, placing the various photographic assets into the appropriate modes with appropriate lighting ratios configured, as well as configuring both cameras as well as the communication device itself may be fairly complex and time consuming and may be confusing to a novice user. The user may contact a customer service person for example by phone, the customer service person may instruct the user to place the photographic asset in an assist mode and establish a communication between a computer of the customer service person and the photographic asset via network. The user may describe the desired operation of the various photographic assets as discussed above. The customer service person may configure all equipment remotely via the network connection then save all appropriate configuration parameters to a memory of the communication device, then give those parameters a meaningful name. In the future, when the user has desire to configure their photographic assets in this configuration, the user may simply select the stored configuration parameter file from a list which may be viewable on a graphic display of the communication device, whereupon the selection, the communication device sets the required parameters of the communication device as well as any other photographic assets for example the cameras and lighting devices discussed.

A remote database may also store a record of all settings which may be communicated and/or changed with or by a customer service person such that a record may be available to the user and/or customer service person of a past history of changed settings of the photographic asset. This may be useful to reference in subsequent contact of the user with a customer service person. For example, if a problem was diagnosed and corrected during a previous contact between a user and a customer service person, during a subsequent contact by a user to a customer service person the previous settings, status, problem indicators, and resolution from the first contact may be referenced during subsequent contacts. This may be useful in establishing patterns and may benefit the user who may be frustrated by an issue, as the issue does not need to be completely re-explained to the customer service person.

In a similar way a customer service person may remotely enable or disable various licensed functions of a photographic asset.

Customer Service Operation via Cellular Phone

In yet another example embodiment in accordance with the present disclosure, it may be possible to implement a means of allowing a customer service person to view, query, and/or update any various data, settings, parameters, and the like as that previously described using information which may be communicated via various wireless technologies including cellular phone service.

In one example embodiment, a photographic asset may comprise a wireless radio transmitter and/or receiver such as but not limited to a BlueTooth, WiFi 802.11, ZigBee, or similar transmitter, or an IrDA transmitter and/or receiver which communicate signals using optical pulses of light, or a wired or corded connection or any combination thereof such that the photographic asset may be able to communicate signals to and/or from a cellular phone, personal digital assistant (“PDA”) such as but not limited to an Apple iPhone, BlackBerry, Palm Pilot, etc. In such example, a photographic asset may be able to communicate with a wireless device such as a cellular phone or PDA. The communication may be partially made possible by software running on the cellular phone or PDA. The photographic asset may encode various signals which may indicate various data, settings, status, error conditions, etc, and send those signals to the cellular phone or PDA. The cellular phone or PDA or a software running on a cellular phone or PDA may be able to generate a message such as an email message, an SMS text message, or similar transmission which may comprise the signals or data representative of signals which may represent the various indications of data, settings, status, error conditions, etc, of the photographic asset. The email message or SMS text may be sent by the cellular phone or PDA to a remote server via a network, wireless, cellular, or other connection such that the remote server is able to route the message or the representative data content of the message to a customer service person. It is possible that an SMS text message may comprise various delimited data fields which may contain alpha numeric, numeric, binary, hexadecimal, etc data which may be preceded by or followed by an indication of the significance of the data, or the fields may be delimited by a known character, such that the pertinent data may be parsed back out of the message by the remote server. For example, assume a photographic asset has comprised a sequence of memory locations which may store an error condition status as an 8-bit variable, followed by five other memory locations which may store various settings and coded conditions as five 8-bit variables, for a total of six 8-bit variables which may together or in part indicate one or more setting, status, or condition of a photographic asset. If the six 8-bit variable locations comprise the following integer data between 0 and 255: 0, 128, 100, 98, 200, 255, those data may be represented by hexadecimal notation wherein two alpha numeric characters may be able to represent any 8-bit data value. As it may be known that each two characters represent a given value, no delimiter or separator may be required between the data elements. An SMS text message may be generated: 00806462C8FF (which may be the hexadecimal representation of the above listed sequence of values) which may be sent to a remote server and thus indicate the sequence of memory locations. A similar sequence may be sent via an email message from a cellular phone or PDA in a similar way. A message could be encoded in any possible way with any possible meaning in any possible sequence, the example provided is for illustration only. Sending alpha numeric characters representative of hexadecimal values may be advantageous as it may be desirable to send a message having as few alphanumeric characters as possible, and a hexadecimal notation “FF” takes only two characters, where a decimal or integer representation “255” would require three characters.

In a similar way, a customer service person may change certain settings or alter various status and send an email message or SMS text message the other direction back to a cell phone or PDA in use by a user, wherein a software of the cell phone or PDA may parse the received message for various pertinent settings, values, etc and may via a connection such as a wired connection, BlueTooth, WiFi 802.11, ZigBee, etc communicate the received settings, values, etc, back to the photographic asset which may set, implement, or execute said settings.

Thus, having the present examples embodiments in accordance with the present disclosure, it may be possible for a user who is on location and involved in a photographing process to experience a problem or attempt to set a condition or process which may not function as they expect. The user may contact a customer service person by cell phone or text message, and may be able to cause a photographic asset to enter an assist mode and to communicate various settings and data to their cell phone or PDA which may further encapsulate data representative of the various settings and data into an SMS text message, email, or other communication which may be sent to the customer service person. The customer service person may be able to diagnose the problem and communicate the issue verbally to the customer via cell phone call, or text message, or may be able to change a data which may correspond to a setting of the photographic asset and cause a second email, SMS text message, or other communication to be sent back to the user's cell phone or PDA which may comprise the altered data which may correspond to an altered setting, and whereby the user's cell phone or PDA or a software running on a cell phone or PDA may further communicate the updated information, data, setting, etc back to the photographic asset which may cause the altered setting to be implemented. Thus, a user may be able to quickly and easily contact a customer service person regarding a problem or confusion in the configuration of a photographic asset or system of photographic assets which may be technically challenging or confusing to the user, and wherein the customer service person may be well skilled in the configuration of said photographic assets and wherein having various setting and configuration data representative of the current settings, configuration, status, etc, of the photographic asset or system of photographic assets being configured by the user presented to the customer service person, the customer service person may cause the various elements of photographic assets to become configured properly to achieve the response desired by the user or to clear an error condition or to diagnose a problem, etc, and wherein the described process may be achieved without the user needing to connect a photographic asset to a computer having a network connection or Internet connection, rather the process may be carried out using a wireless connectivity provided by a cellular phone or PDA which the user may have with them in the field or on the location of the photo shoot, etc.

Example Modes of Manufacture and Implementation

The various systems and methods described herein may be implemented by one skilled in the art of computer databases such as relational database management systems (RDMS) such as but not limited to MySQL available under open source license, by someone skilled in the art of computer software programming, networking systems including TCP/IP networking, routers, firewalls, etc, by someone skilled in the art of electronic circuit design, programming of microprocessors, digital and analog circuitry, and wireless communication systems such as but not limited to radio transmitter and radio receiver circuitry. Some suggestions and guidelines are discussed below which may or may not be essential steps or components for the implementation of the present invention, may be used together, in part, or any combination thereof, and may be altered somewhat or significantly while still providing substantially the useful benefits in accordance with the present disclosure. Additional software, circuitry, connectivity, components, apparatus, controllers, processors, interfaces, software drivers, and the like may be used as well.

A remote server may comprise a computer circuit board or motherboard which may comprise one or more central processing unit(s), disk drive(s), network interface(s), power supply(s), etc. The remote server may comprise an operating system such as Linux, available under open source license and may further comprise a relational database system such as MySQL, also available under open source license, and may further comprise a firewall which may limit access to the remote server. The remote server may comprise also a web server such as Apache, available under open source license. Various components of a database and/or web server and/or other software may exist on a plurality of servers which are able to communicate with each other.

A web server may serve a sequence of one or more web pages which may include various scripting elements such as PHP which may allow the scripting of the web pages to perform some logical function, retrieve user input to forms of a web page, query a database, etc. A web page or web pages may include various interactive elements which may include various Java elements which may provide an interactive graphical interface to a user and/or a customer service person.

A computer system used by a customer service person may comprise a purpose designed software application designed to allow the customer service person to see status or indications which may be status or indication of one or more photographic asset(s) which may be remote and to perform the other useful functions of the present invention as previously described.

A photographic asset may comprise an integrated circuit (“IC”) which may be used to enable a unit identification, board ID, or board identification or machine-to-machine authentication such as but not limited to an N211 family IC available commercially from Renesas Technology America, Inc. located in San Jose, Calif. A board identification processes, software, IC, circuitry, or the like may provide various cryptographic functionality and may provide an identification which may allow a hardware or circuitry such as a circuit board to be uniquely identified by another circuitry. It is considered that various methods may be used to provide a unit identification to a photographic asset such as recording a unit identification in a non-volatile memory of a photographic asset, or by compiling a unit identification into a unique compilation of a firmware run by a microprocessor, or by referencing a serial number of a microprocessor or other circuitry of a photographic asset, or other method. It should be considered that a unit identification or process or circuitry providing a unit identification should not be easily tampered with. The suggested N211 may provide a secure means of validating a given photographic asset and communicating a unit identification with another device such as a microprocessor, or a controller, or another circuitry which may provide connectivity between a photographic asset and a computer system such as a USB connection.

It may be possible for a malicious user to send signals to a photographic asset which may cause the photographic asset to enable various licensed functions without properly querying a remote database. As a security measure, it may be beneficial to allow a software process or peripheral functionality of a microprocessor of a photographic asset to encrypt any data which may be exchanged with another device via for example USB to a personal computer. The microprocessor performing the encryption should also be the microprocessor having the licensed functions. It may be advisable also to include in any communication which may include a license flag or data which would enable a licensed function a key or authenticator which may be stored uniquely for each unit identification in a remote database and may correspond to a key or authenticator which may have been programmed to a photographic asset at the time of manufacture and assignment of the unit identification to the photographic asset, and wherein before a licensed function is enabled, the keys must match or authenticate. If the keys have been maintained secure, it is not likely that a malicious user would be able to recreate a sequence of data or signals that would cause a licensed function to become enabled as they would not be able to match the key or authenticator. Moreover, upon an attempt to communicate with a photographic asset with a non-matching or incorrect authentication key, the photographic asset may be programmed to freeze, pause, or otherwise delay for a period of time before another attempt may be made, and thus significantly increasing the amount of time that would be required to simply try every possible bit sequence of authentication key. Various encryption methods may be useful or desirable including Advanced Encryption Standard (AES), shared key, open key, and similar methods of establishing encrypted communication between two or more devices or circuitry.

A photographic asset may have also specific memory locations programmed with specific values which may include a checksum or indication as to the validity of a program or firmware running on the photographic asset, or may implement a scheme of processing a unit identification along with a checksum of a firmware or firmware storage memory locations whereby a software or circuitry of a photographic asset may become aware if a firmware has been altered, or has been reprogrammed with a firmware other than an authentic and authorized firmware from the manufacturer of the photographic asset. For example, if a malicious user attempts to write a firmware which may cause one or more licensed functions to be enabled regardless of the status of one or more license flags, the photographic asset may be aware that the firmware has been replaced with an unauthorized firmware and may stop working.

It is suggested in accordance with the present disclosure that any communication between any computer, cellular phone, PDA, or other computing device which may be used by a user, a customer service person, and a remote database and/or a remote server should all be encrypted to prevent malicious interaction with the intended communications between the various devices. Any connection between a computing device in use by a user and a photographic asset should also be encrypted for similar reasons.

It is considered by the present disclosure and should be clear to the reader that through the various example embodiments, explanations, disclosure, illustrations, and discussion presented in this provisional patent application various references may be made for illustration and are not necessarily limited by the specific examples presented. For example, a USB connection which may be used to couple various devices together, may be replaced by or used together with another interface such as but not limited to a serial peripheral interface (“SPI”) such as that which may be communicated by various electrical contacts of a hot shoe connector of a camera, an HDMI interface, a port for the attachment of an accessory control device such as a remote shutter release button, pan tilt zoom controller, etc, as well as any port either commercially standardized or proprietary to a given device, photographic hardware, photographic asset, etc, which may send signals or data which may be of use to a second device or photographic hardware, or which may be responsive to signals or data from a second device or photographic hardware, including any means of allowing two devices or photographic hardware to communicate in one direction or bidirectionally which may be available or yet to be developed such as but not limited to wireless USB, WiFi, BlueTooth, ZigBee, mesh networking, machine to machine (“M2M”), IrDA, and others. In a similar way, it is clear that various networking methods commercially available or yet to be developed which may allow a circuitry to send and/or receive signals or data to or from another device via any wireless means or any networking means may be used as appropriate in various example embodiments.

Throughout this discussion an example of a wireless communication device has been used to explain many of the example embodiments of the present invention and the methods of the present invention. It is considered and should be clear that the various embodiments may be applied directly to cameras, lighting devices, light positioning devices, devices which modify or control the reflection or diffusion of light, and the like.

In the foregoing specification, the invention has been described with reference to specific example embodiments. Various modifications and changes may be made, however, without departing from the scope of the present invention as set forth in the claims. The specification and figures may be illustrative, rather than restrictive, and modifications may be intended to be included within the scope of the present invention. Accordingly, the scope of the invention should be determined by the claims and their legal equivalents rather than by merely the examples described.

For example, the steps recited in any method or process claims may be executed in any order and may be not limited to the specific order presented in the claims. Additionally, the components and/or elements recited in any apparatus claims may be assembled or otherwise operationally configured in a variety of permutations and may be accordingly not limited to the specific configuration recited in the claims.

Benefits, other advantages and solutions to problems have been described above with regard to particular embodiments; however, any benefit, advantage, solution to a problem or any element that may cause any particular benefit, advantage or solution to occur or to become more pronounced may be not to be construed as critical, required or essential features or components of any or all the claims.

As used herein, the terms “comprise”, “comprises”, “comprising”, “have”, “has”, “having”, “including”, “includes”, “employs”, “employing” or any variation thereof, may be intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A photographic asset comprising:
one or more functional features configured to enable the photographic asset to perform one or more functions;
a memory configured to hold a photographic asset identifier;
a communication mechanism configured to couple with a data handler and to provide the asset identifier to the data handler, and to receive a licensure status from the data handler, the licensure status obtained from a cross referencing of the asset identifier against a license flag in a database, the database including a copy of the asset identifier and the license flag, the license flag including the licensure status; and
an enabling or disabling feature to respectively enable, or keep enabled, at least one of the one or more functions when the licensure status indicates that the at least one function is licensed, and to not enable or to disable the at least one function when the licensure status indicates that the at least one function is not licensed.

2. The photographic asset of claim 1, including a user display configured to display one or more settings and/or status indicators of the photographic asset and/or one or more photographic elements operatively coupled with the photographic asset; and
wherein the communication mechanism is further configured to communicate with a remote display and to cause the remote display to display a representation of the one or more settings and/or status indicators of the photographic asset and/or the photographic elements operatively coupled with the photographic asset.

3. The photographic asset of claim 1, wherein the communication mechanism is further configured to communicate with an interface accessible to a service person at a location remote from the photographic asset and wherein the interface is configured to allow the service person to observe one or more settings and/or status indicators of the photographic asset and/or photographic elements operatively coupled to the photographic asset.

4. The photographic asset of claim 1, wherein the photographic asset identifier includes one or more of a hardware ID which is unique to the individual photographic asset, and a model ID which is unique to a group of photographic assets all having features substantially similar to the photographic asset.

5. The photographic asset of claim 1, wherein the database includes an expiration date indicating a date when the licensure status of the one or more functional features changes from licensed to unlicensed.

6. The photographic asset of claim 1, wherein the licensure status is set as licensed for predetermined time periods by setting or clearing predetermined license flags.

7. The photographic asset of claim 6, wherein the license flags are one or more of:
set to be permanently valid,
set on a month by month basis,
set on a recurring time period basis, and
set for a predetermined period.

8. A method comprising:
configuring a photographic asset, capable of performing at least one function useable in a photographic setup arranged to capture a photographic image, to include an enabling or disabling feature to respectively enable, or keep enabled, the at least one function when a licensure status indicates that the at least one function is licensed, and to not enable or to disable the at least one function when the licensure status indicates that the at least one function is not licensed;
associating a photographic asset identifier with the photographic asset;
configuring a database to include one or more records, each of the one or more records including a copy of the photographic asset identifier, and a related license flag, the license flag indicating the licensure status of the at least one function; and
enabling a communication mechanism to communicate the photographic asset identifier to a data handler, the data handler configured to cross check the photographic asset identifier against the license flag in the database, and to return the licensure status of the at least one function to the photographic asset via the communication mechanism.

9. The method of claim 8, further comprising saving the photographic asset identifier in a memory included in the photographic asset.

10. The method of 8, further comprising:
providing a request interface whereby a user can request one or more licensable functions to be usable by the photographic asset;
receiving a request via the request interface to make a licensable function usable by the photographic asset;
setting a license flag in the database in response to the request in order to change the licensure status of the requested function from unlicensed to licensed; and
communicating via the communication mechanism to the photographic asset that the requested function is licensed.

11. The method of claim 10, wherein the request interface is one or more of a telephonic interface, and an Internet based interface.

12. The method of 8, further comprising:
using a customer service interface at a location remote from the photographic asset to change one or more settings of the photographic asset and/or one or more settings of one or more photographic elements operatively coupled with the photographic asset.

13. The method of 8, further comprising:
saving two or more settings from any combination of settings of the photographic asset or settings of one or more the photographic elements operatively coupled with the photographic asset as a collection of settings;
associating a collection name with the collection of settings;
retrieving the two or more settings as the collection of settings by using the collection name as a search term; and
communicating the collection of settings to the photographic asset, and thereby changing or affirming corresponding settings of the photographic asset and/or the photographic elements coupled with the photographic asset.

14. A system comprising:
a photographic asset configured to perform at least one function in a photographic setup, the photographic setup configured to capture a photographic image, the photographic asset having a photographic asset identifier designated to identify the photographic asset;
a memory configured to contain at least a portion of a database, the database including one or more records, each of the one or more records including a copy of the photographic asset identifier, and a related license flag, the license flag indicating a licensure status of the at least one function;
a processor enabled data handler;
a communication mechanism configured to communicate the photographic asset identifier to the data handler, the data handler configured to cross check the photographic asset identifier against the license flag in the database, and to return the licensure status of the at least one function to the photographic asset via the communication mechanism; and
an enabling or disabling feature to respectively enable, or keep enabled, the at least one function when the licensure status indicates that the at least one function is licensed, and to not enable or to disable the at least one function when the licensure status indicates that the least one function is not licensed.

15. The system of claim 14, wherein the communication mechanism includes one or more of:
a USB connection connecting the photographic asset to a computing device, the computing device including the memory;
a network connection which utilizes the Internet connecting the photographic asset to a remote computing device, the remote computing device including the memory;
a wireless connection coupling the photographic asset to the database; and
a telephonic connection coupling the photographic asset to the database.

16. The system of claim 14, wherein the photographic asset includes an asset memory configured to hold the photographic asset identifier.

17. The system of claim 14, wherein the communication mechanism is further configured to provide a customer service person information indicative of one or more settings of the photographic asset and/or one or more other settings of one or more photographic devices coupled with the photographic asset, and
wherein the communication mechanism is further configured to provide signals to the photographic asset to enable the customer service person to remotely change one or more of the one or more settings of the photographic asset or the one or more photographic devices coupled with the photographic asset.

18. The system of claim 14, wherein the data handler is configured to receive a request via one or both of a telephonic device or the Internet to change one or more settings of the photographic asset or the one or more photographic devices coupled with the photographic asset.

19. The system of claim 14, wherein the communication mechanism is further configured to provide a customer service person information indicative of one or more settings of the photographic asset and/or one or more settings of an additional photographic asset, and to enable the customer service person to remotely change one or more of the one or more settings of the photographic asset and/or the additional photographic asset.

20. The system of claim 14, further comprising a computing device having a display visible to a customer service person wherein the computing device is coupled with the photographic asset via a network connection and wherein the computing device is configured to display one or more settings of the photographic asset and/or one or more additional photographic assets.

21. The system of claim 14, wherein the photographic asset and/or an additional photographic asset each collectively include two or more settings, and the data handler is configured to save the two or more settings as a collection of settings and to assign a collection name to the collection of settings, and wherein the collection of settings can be recalled from the database by the data handler using the collection name as a search term, and wherein the data handler can configure the photographic asset and/or the one or more additional photographic assets as a group by communicating the collection of recalled settings to the photographic asset.
